(19) United States
(12) Patent Application Publication
(10) Pub. No.: US 2016/0277868 A1
(43) Pub. Date: Sep. 22, 2016

(54) Method and System for Changing Language on a Smart Device From a Personal Electronic Device

(71) Applicant: James E. NILES, New York, NY (US)

(72) Inventor: James E. NILES, New York, NY (US)

(21) Appl. No.: 15/072,108

(22) Filed: Mar. 16, 2016

Related U.S. Application Data
(60) Provisional application No. 62/133,745, filed on Mar. 16, 2015.

(51) Int. Cl. H04W 4/00; H04L 29/08; H04L 12/24

(52) U.S. Cl. CPC H04W 4/001; H04L 41/0886; H04L 67/10

(57) ABSTRACT

A process for automatically changing the language on smart device(s)/internet of thing device(s)/internet of everything device(s) based on consumer/traveler/end-user personal smart mobile device or other personal electronic smart device(s) native language (locale). The smart device(s)/internet of thing device(s)/internet of everything device(s) communicates with the personal smart mobile device or other personal electronic smart device(s) and determines the native language (locale) of the consumer/traveler/end-user. The native language of the consumer/traveler/end-user is used to set the language on the smart device(s)/internet of thing device(s)/internet of everything device(s) or to change the language of the content. Once language is changed, the consumer/traveler/end-user has a better user experience with smart device(s)/internet of thing device(s)/internet of everything device(s).

### RELATED APPLICATIONS

The present application is a non-provisional application of provisional Application No. 62/133,745 filed on Mar. 16, 2015, the contents of which are incorporated by reference in its entirety.

### TECHNICAL FIELD

The present invention relates generally to communication and interaction with consumers/end-users (sometimes referred to herein as a “user”) who may not speak or understand the default language displayed on smart devices/internet of thing device/internet of everything device (sometime collectively referred to herein as a “smart device”) as it is not in their (consumer/end-user) native language. More particularly, the present invention relates to a process and method for allowing users to change language settings on other smart device(s)/internet of thing device(s)/internet of everything device(s) (sometime collectively referred to herein as a “personal electronic device” or “PED”) automatically by referencing/synchronizing the default native language on the consumer smart mobile device or other personal smart electronic devices.

### BACKGROUND

A consumer/end-user now expects a full seamless user experience when using smart device(s)/internet of thing device(s)/internet of everything device(s). Manually changing the language of those device(s) is time consuming and/or frustrating for end-users especially if the end-user does not understand the language to begin with. Furthermore, the consumer/end-user many not have the option to make those changes manually for various reasons which may include direct access to the setup configuration menu or direct access to the other smart device(s)/internet of thing device(s)/internet of everything device(s). In today's environment, more and more smart device(s)/internet of thing device(s)/internet of everything device(s) are being implemented throughout society but the consumer/end-user native language may not be the primary language on the other smart device(s)/internet of thing device(s)/internet of everything device(s) which then doesn't provide a full user experience because of the different language barrier.

Considering that hundreds of millions of people who travel internationally each year to countries where language other than their own are spoken, displayed, or written, it is a frequent occurrence that travelers are unable to understand the information that is provided in order for them to act appropriately. As such, information that is displayed on smart device(s)/internet of thing device(s)/internet of everything device(s) could be a safety concern for travelers, which they may not understand as it is not in their native language.

While industries have attempted to provide consumer(s)/end-user(s) a complete user experience, they have fallen short because of the foreign language barrier that exist between the mobility of consumer(s)/end-user(s) and other smart device(s)/internet of thing device(s)/internet of everything device(s). Thus, while these other smart device(s)/internet of thing device(s)/internet of everything device(s) may be suitable for the particular purpose employed, or for general use, they would not be as suitable for the purpose of the present disclosure as disclosed hereafter.

In the present application, where a document, act or item of knowledge is referred to or discussed, this reference or discussion is not an admission that the document, act or item of knowledge or any combination therefor was at the priority date, publicly available, known to the public, part of common general knowledge or otherwise constitutes prior art under the applicable statute provisions; or is known to be relevant to an attempt to solve any problem with which the present disclosure is concerned.

While certain aspects of conventional technologies have been discussed to facilitate the present disclosure, no technical aspects are disclaimed and it is contemplated that the claims of this application or any future application claiming the benefit of this application may encompass one or more of the conventional technical aspect discussed herein.

### BRIEF SUMMARY

An aspect of an example embodiment in the present disclosure is to provide a process and method for automatically setting/changing an active language (locale) or changing content language on smart device(s)/internet of thing device(s)/internet of everything device(s), which a consumer/end-user/traveler may encounter and have that smart device default language set as the consumer native language. Providing automatic language configuration from smart device(s)/internet of thing device(s)/internet of everything device(s) to a consumer in their native language then produces a complete seamless integrated user experience. Initially the default smart device language is set by reference to the consumer's smart mobile device or other smart personal electronic device, which may be carried by the consumer/end-user to determine a locale language of the consumer/end-user native language automatically.

It is another aspect of an example embodiment in the present disclosure to provide a fulfilling user experience to the consumer/end-user by having a seamless integration of smart devices. When connection between a consumer/end-user smart mobile device and other smart device(s)/internet of thing device(s)/internet of everything device(s) is made; and the consumer native language is set automatically, then the consumer/end-user experience is fulfilling. Seamless integration happens when a consumer/end-user smart mobile device(s) or other smart personal electronic device(s) communicates with other smart device(s)/internet of thing device(s)/internet of everything device(s), which for example could be cellular, Wi-Fi, Bluetooth, NFC (near field communication), RFID, Ultra-sonic, Beacon communication, or any other network communication system, which will allow connectivity between all the internet of things/smart devices. Connectivity may require that a mobile smart device or other personal smart device(s) and other smart device(s)/internet of thing device(s)/internet of everything device(s) to have an IP Address as a unique identifier or another form of a device unique identifier so that all devices can communicate with each other. Connectivity may require that such other smart device(s)/internet of thing device(s)/internet of everything device(s) and/or mobile smart device or other personal smart device(s) to be turned on (having power) prior to connection.

It is yet another aspect of an example embodiment to determine the language on other smart device(s)/internet of thing device(s)/internet of everything device(s) automatically based on consumer/traveler/end-user smart mobile device or other personal smart electronic device(s) native language (locale). Connectivity between the other smart device(s)/internet of thing device(s)/internet of everything device(s) and consumer/end-user mobile smart device or other personal smart device(s) may occur by placing the devices near each other; or by tapping the devices together; or by placing the devices together; or by pointing or waving the device at the smart device; or device connectivity based on proximity (geo-referencing location). Automatically changing the smart device or content language does not require any other action from consumer/traveler/end-user besides what is mentioned in this embodiment.

It is yet another aspect of an example embodiment to determine the preferred language of the consumer/end-user when the default language of the personal smart mobile device or other personal smart electronic device cannot be determined. Accordingly, scanning email or text message on consumer/end-user smart phone to detect examples of native language usage may also be used in determining other smart device(s)/internet of thing device(s)/internet of everything device(s) default language (locale). Additionally, consumer/end-user default native language (locale) may be stored within an app on the personal smart mobile device or other personal electronic device(s).

It is yet another aspect of an example embodiment to determine the device or content language (locale) on other smart device(s)/internet of thing device(s)/internet of everything device(s) may be changed several different ways based on consumer/end-user smart mobile device or other personal smart electronic device(s). Currently there are four main techniques for changing the default language on other smart device(s)/internet of thing device(s)/internet of everything device(s) which consist of automatically changing (no other action required); pre-installing language packs; language translation by way of software or hardware (example may be API or OS or chip or software application based); or language translation using cloud based system. Once the connectivity between devices occurs and based on consumer/end-user native language (locale) on their personal smart mobile device or other personal smart electronic device(s), the best technique option will take place to change other smart device(s)/internet of thing device(s)/internet of everything device(s) language (locale). One or a combination of these techniques may be used to change the device or content language on other smart device(s)/internet of thing device(s)/internet of everything device(s). In addition, language translation may use a 3^{rd} party application to translate other smart device(s)/internet of thing device(s)/internet of everything device(s) default language or content language based on consumer/end-user smart mobile device or other personal smart electronic device(s) native language (locale) automatically.

In summary the invention encompasses a process/method for changing the language on smart device(s)/internet of thing device(s)/internet of everything device(s) based on consumer/traveler/end-user personal smart mobile device or other personal electronic smart device(s) native language (locale) and includes the following:

communication between a personal smart mobile device or other personal electronic smart devices and smart device(s)/internet of thing device(s)/internet of everything device(s);

determining the consumer/traveler/end-user native language (local) from personal smart mobile device or other personal electronic smart device(s); and

changing smart device(s)/internet of thing device(s)/internet of everything device(s) language or content language to match consumer/traveler/end-user native: or Smart device(s)/internet of thing device(s)/internet of everything device(s) language change/translation could happen automatically with no further action required; or Smart device(s)/internet of thing device(s)/internet of everything device(s) language change/translation could happen with pre-installed language; or Smart device(s)/internet of thing device(s)/internet of everything device(s) language change/translation could happen with software or hardware; or Smart device(s)/internet of thing device(s)/internet of everything device(s) language change/translation could happen with cloud based service; and

when the Smart device(s)/internet of thing device(s)/internet of everything device(s) language matches consumer/traveler/end-user native language (locale) from their personal smart mobile device or other personal electronic smart device(s), then Smart device(s)/internet of thing device(s)/internet of everything device(s) is ready to be used by consumer/traveler/end-user.

The system of the invention for changing the language on smart device(s)/internet of thing device(s)/internet of everything device(s) based on consumer/traveler/end-user personal smart mobile device or other personal electronic smart device(s) native language (locale) includes:

a personal smart mobile device or other personal electronic smart devices (herein “personal electronic device”) in communication with a smart device(s)/internet of thing device(s)/internet of everything device(s) (herein “smart device”);

means on said personal electronic device for determining the consumer/traveler/end-user native language (local); and

means for changing language or content language of said smart device to match the consumer/traveler/end-user native:

the means for changing the language of the smart device being a software application on the personal electronic device or cloud based; and

so that when the Smart device language matches the consumer/traveler/end-user native language (locale) from its personal electronic device, then the Smart device is ready to be used by the consumer/traveler/end-user.

The present invention addresses at least one of the foregoing disadvantages. However, it is contemplated that the present disclosure may prove useful in addressing other problems and deficiencies in a number of technical areas. Therefore, the claims should not necessarily be construed as limited to addressing any of the particular problems or deficiencies discussed hereinabove. To the accomplishment of the above, this disclosure may be embodied in the form described in the accompany drawings. Attention is called to the fact, however that the drawings are illustrative only. Variations are contemplated as being part of the disclosure.

### BRIEF DESCRIPTION OF THE DRAWINGS

In the drawings, like elements are depicted by like reference numerals. The drawings are briefly described as follows.

FIG. 1 is an overall flow diagram, illustrating steps for changing other smart device(s)/internet of thing device(s)/internet of everything device(s) language or content language to consumer/traveler/end-user native language (locale) based on their personal smart mobile device or other personal smart electronic device(s).

FIG. 2 is an flow diagram using the automatic language changing technique, illustrating steps for changing smart device(s)/internet of thing device(s)/internet of everything device(s) language or content language to consumer/traveler/end-user native language (locale) based on their personal smart mobile device or other personal smart electronic device(s) language.

FIG. 3 is an flow diagram using the pre-installed language changing technique, illustrating steps for changing smart device(s)/internet of thing device(s)/internet of everything device(s) language or content language to consumer/traveler/end-user native language (locale) based on their personal smart mobile device or other personal smart electronic device(s) language.

FIG. 4 is an flow diagram using software or hardware language changing technique, illustrating steps for changing smart device(s)/internet of thing device(s)/internet of everything device(s) language or content language to consumer/traveler/end-user native language (locale) based on their personal smart mobile device or other personal smart electronic device(s) language.

FIG. 5 is an flow diagram using cloud base language changing technique, illustrating steps for changing smart device(s)/internet of thing device(s)/internet of everything device(s) language or content language to consumer/traveler/end-user native language (locale) based on their personal smart mobile device or other personal smart electronic device(s) language.

FIG. 6 is an illustration example showing changing of smart device(s)/internet of thing device(s)/internet of everything device(s) language or content language to consumer/traveler/end-user native language (locale) based on their personal smart mobile device or other personal smart electronic device(s) language in proximity to smart devices.

### DETAILED DESCRIPTION OF THE PREFERRED EMBODIMENTS

What follows are descriptions of various scenarios that follow the principles of the present disclosure. As appropriate through these examples, a consumer/end-user smart mobile device or other personal smart electronic device carried by the consumer/end-user is used to determine the device/content language of other smart device(s)/internet of thing device(s)/internet of everything device(s) language.

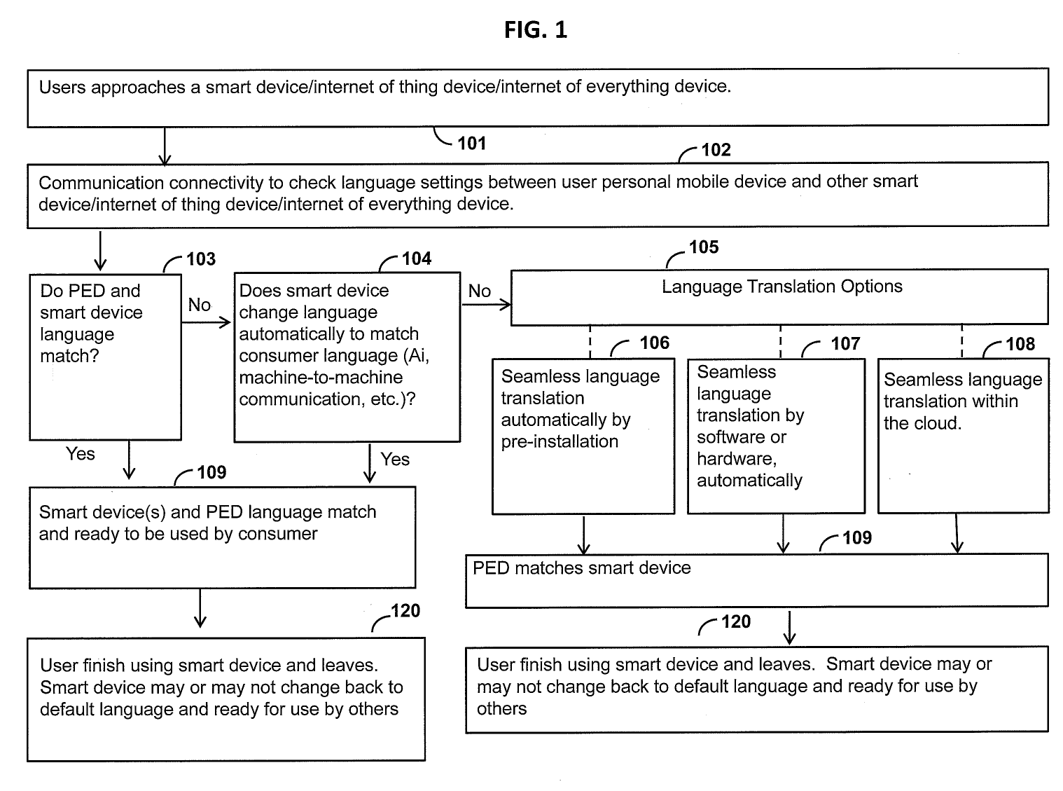

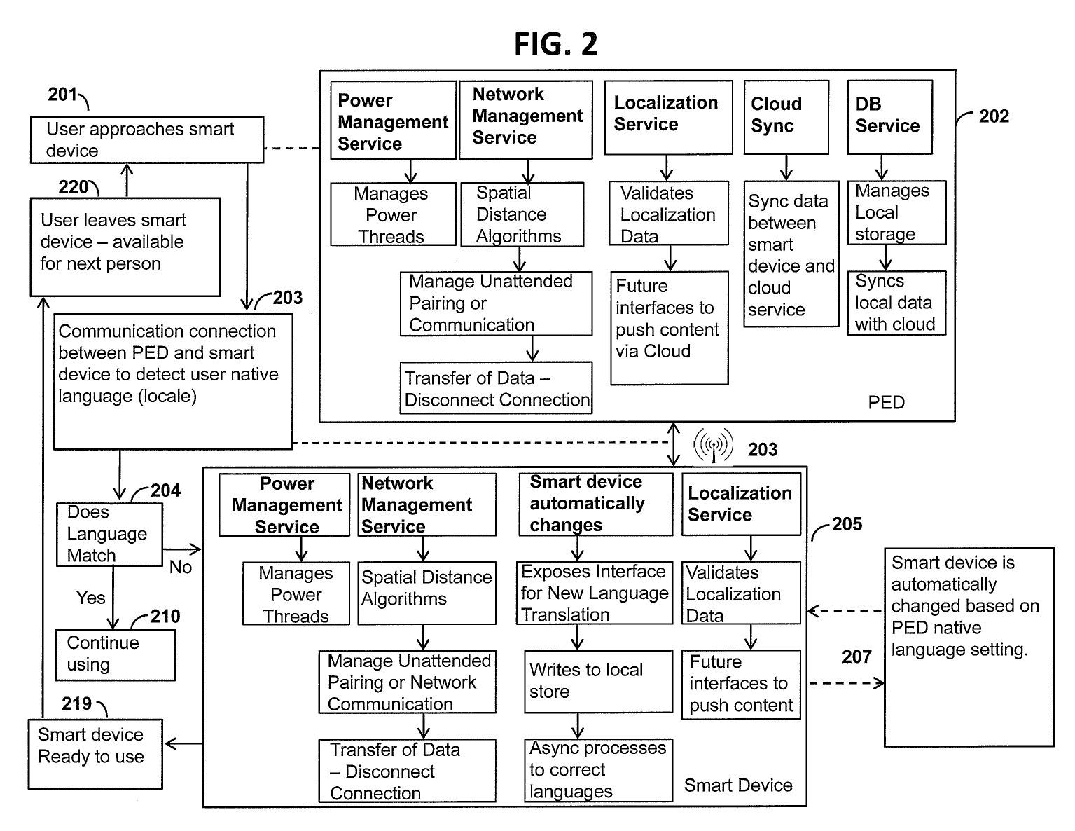

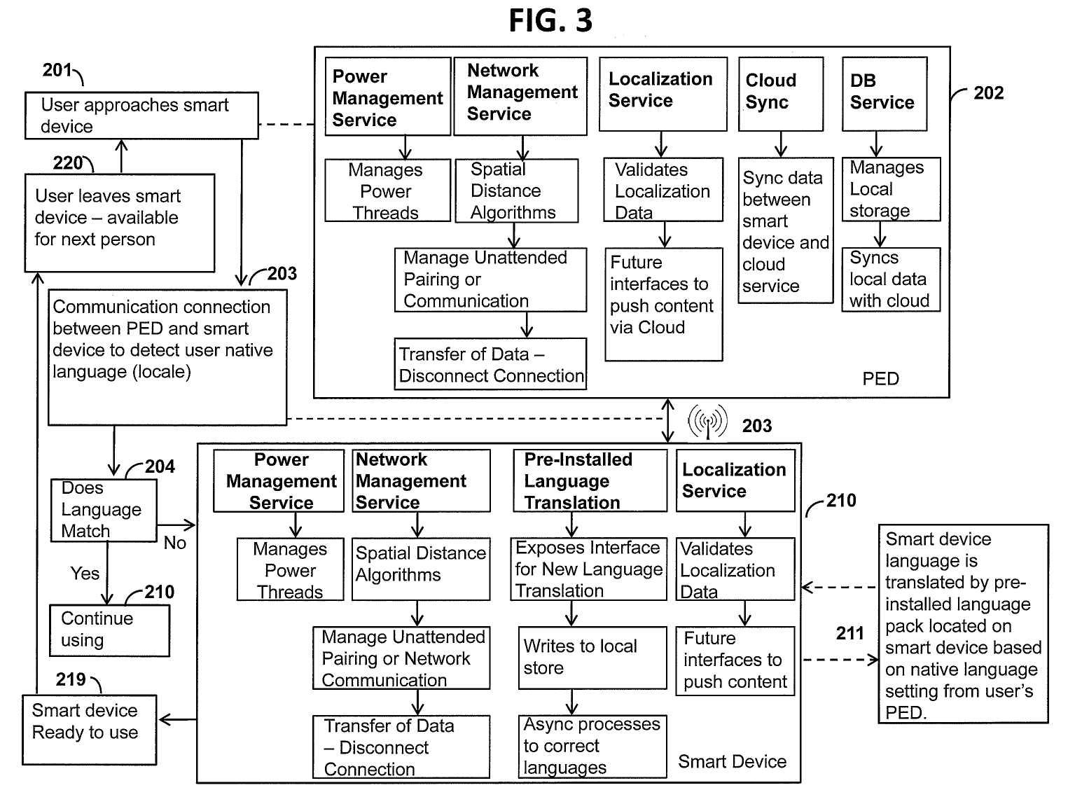

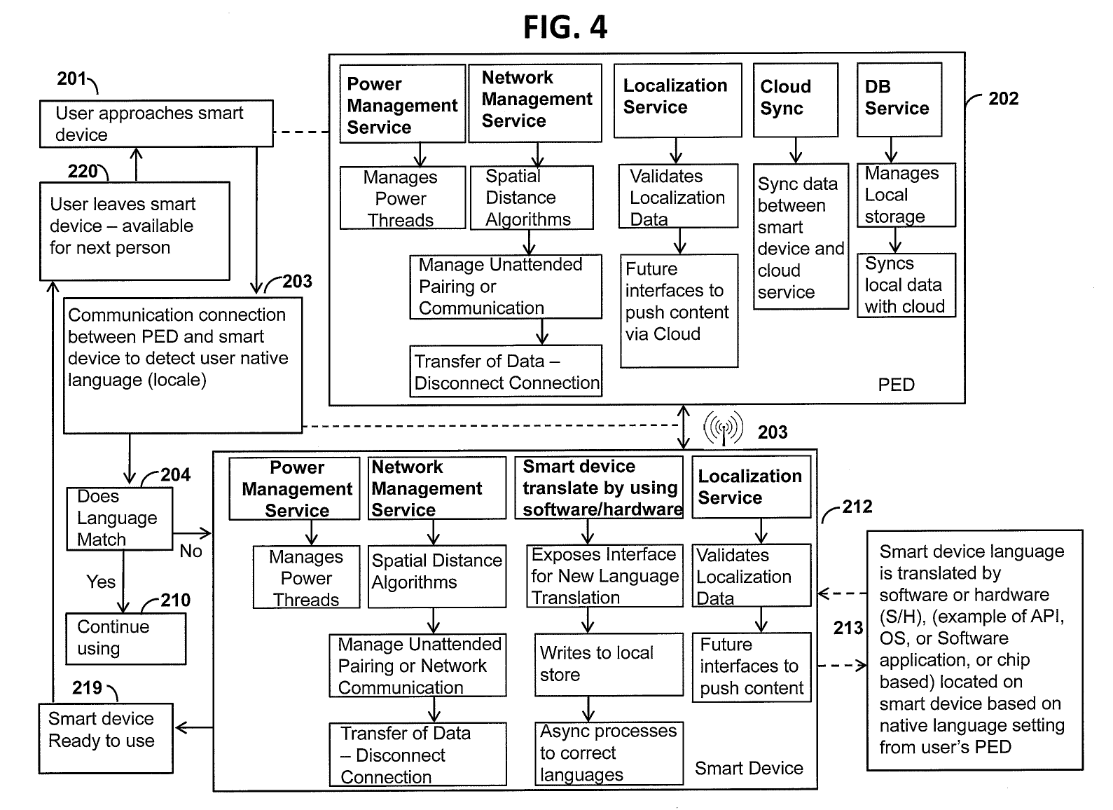

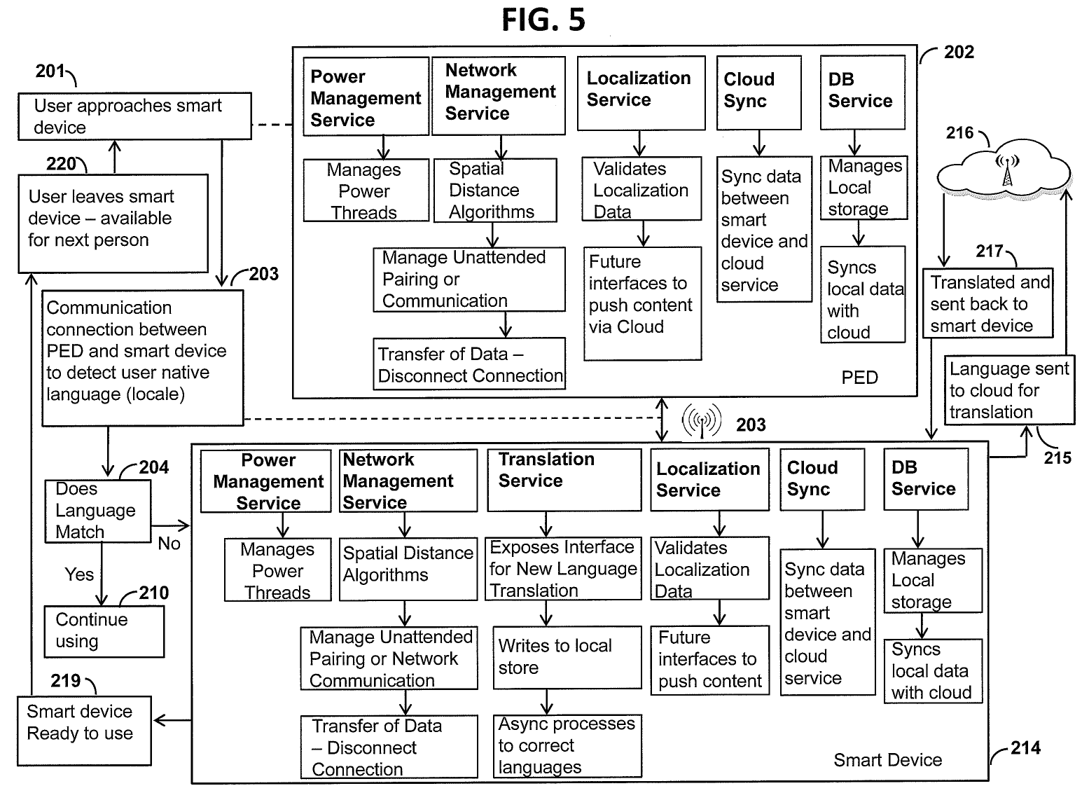

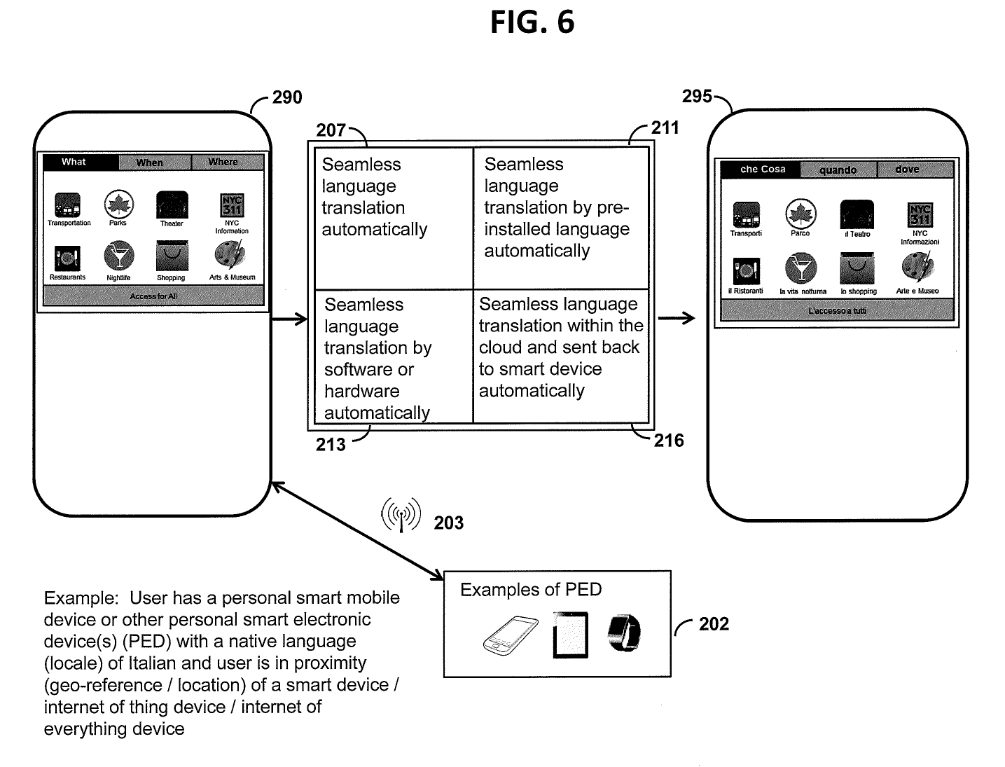

FIG. 1 illustrates at step 101 where a consumer/end-user (person) 110 approaches, or is in proximity with, a smart device(s)/internet of thing device(s)/internet of everything device(s) with their smart mobile device or other personal smart electronic device(s) (such as 202 in FIG. 2, FIG. 3, FIG. 4, FIG. 5, FIG. 6). Communication connectivity occurs at step 102 between a consumer/traveler/end-user personal smart mobile device and/or other personal electronic smart device(s) and other smart device(s)/internet of thing device(s)/internet of everything device(s) to check language settings. If smart device(s)/internet of thing device(s)/internet of everything device(s) and consumer/traveler/end-user personal smart mobile device and/or other personal electronic smart device(s) language (locale) match, then smart device(s)/internet of thing device(s)/internet of everything device(s) is ready to be used by consumer at 110. If smart device(s)/internet of thing device(s)/internet of everything device(s) and consumer personal smart mobile device or other personal smart electronic device(s) don't match, then does the smart device(s)/internet of thing device(s)/internet of everything device(s) change automatically at 104 during the communication connectivity step (such as 207 in FIG. 2) or is further language option 105 required.

FIG. 1 also illustrates the language changing options 105 such as seamless language translation done automatically on smart device(s)/internet of thing device(s)/internet of everything device(s) by pre-installed language packs on the device at step 106. When communication connectivity between smart device(s)/internet of thing device(s)/internet of everything device(s) and consumer/traveler/end-user personal smart mobile device and/or other personal electronic smart device(s) happens 102, the pre-installed language pack will change to match consumer/traveler/end-user native language based on their personal smart mobile device and/or other personal electronic smart device(s) (such as 211 in FIG. 3). When devices match at step 109, then smart device(s)/internet of thing device(s)/internet of everything device(s) is ready to be used by the consumer/traveler/end-user 110.

FIG. 1 also illustrates the language changing options 105 such as seamless language translation done on smart device(s)/internet of thing device(s)/internet of everything device(s) by software or hardware located on the smart device(s)/internet of thing device(s)/internet of everything device(s) on the device at 107. When communication connectivity between smart device(s)/internet of thing device(s)/internet of everything device(s) and consumer/traveler/end-user personal smart mobile device and/or other personal electronic smart device(s) happens 102, the software or hardware will change the device or content language to match consumer/traveler/end-user native language based on their personal smart mobile device and/or other personal electronic smart device(s) (such as 213 in FIG. 4). When devices match at step 109, then smart device(s)/internet of thing device(s)/internet of everything device(s) is ready to be used by consumer/traveler/end-user 110.

FIG. 1 also illustrates the language changing options 105 such as seamless language translation done on smart device(s)/internet of thing device(s)/internet of everything device(s) by cloud base system 108 which sends the request for language translation (such as 215 in FIG. 5) to the cloud based on consumer/traveler/end-user native language. When communication connectivity between smart device(s)/internet of thing device(s)/internet of everything device(s) and consumer/traveler/end-user personal smart mobile device and/or other personal electronic smart device(s) happens 102, a language request is sent to the cloud (such as 215 in FIG. 5) for translation. Once translated, the language content is sent back to the smart device(s)/internet of thing device(s)/internet of everything device(s) (such as 217 in FIG. 5). When devices match, then smart device(s)/internet of thing device(s)/internet of everything device(s) is ready to be used by consumer/traveler/end-user 110.

FIG. 2 illustrates the workflow/process of language translation done on smart device(s)/internet of thing device(s)/internet of everything device(s) automatically 207 based on the user's PED language (locale). When communication connectivity between smart device(s)/internet of thing device(s)/internet of everything device(s) and consumer/traveler/end-user personal smart mobile device and/or other personal electronic smart device(s) happens 203, the device or content language will automatically change without further action. When devices match, then smart device(s)/internet of thing device(s)/internet of everything device(s) is ready to be used by consumer/traveler/end-user 219.

FIG. 3 illustrates the workflow/process of language translation done on smart device(s)/internet of thing device(s)/internet of everything device(s) using pre-installed language 211 based on consumer/traveler/end-user personal smart mobile device or other personal electronic smart device(s) native language (locale). When communication connectivity between smart device(s)/internet of thing device(s)/internet of everything device(s) and consumer/traveler/end-user personal smart mobile device and/or other personal electronic smart device(s) happens 203, the device or content language will change to one of the pre-installed languages automatically. When devices match, then smart device(s)/internet of thing device(s)/internet of everything device(s) is ready to be used by consumer/traveler/end-user 219.

FIG. 4 illustrates the workflow/process of language translation done on smart device(s)/internet of thing device(s)/internet of everything device(s) using software or hardware 213 located on the smart device(s)/internet of thing device(s)/internet of everything device(s) based on consumer/traveler/end-user personal smart mobile device or other personal electronic smart device(s) native language (locale). When communication connectivity between smart device(s)/internet of thing device(s)/internet of everything device(s) and consumer/traveler/end-user personal smart mobile device and/or other personal electronic smart device(s) happens 203, the device or content language will change based on software or hardware action. When devices match, then smart device(s)/internet of thing device(s)/internet of everything device(s) is ready to be used by consumer/traveler/end-user 219.

FIG. 5 illustrates the workflow/process of language translation done on smart device(s)/internet of thing device(s)/internet of everything device(s) using cloud based service 216 based on consumer/traveler/end-user personal smart mobile device or other personal electronic smart device(s) native language (locale). When communication connectivity between smart device(s)/internet of thing device(s)/internet of everything device(s) and consumer/traveler/end-user personal smart mobile device and/or other personal electronic smart device(s) happens 203, the device or content language will change based on cloud translation automatically. When devices match, then smart device(s)/internet of thing device(s)/internet of everything device(s) is ready to be used by consumer/traveler/end-user 219.

FIG. 1, FIG. 2, FIG. 3, FIG. 4, FIG. 5 illustrates the workflow/process of language translation done on smart device(s)/internet of thing device(s)/internet of everything device(s) based on consumer/traveler/end-user personal smart mobile device or other personal electronic smart device(s) native language (locale). When communication connectivity between smart device(s)/internet of thing device(s)/internet of everything device(s) and consumer/traveler/end-user personal smart mobile device and/or other personal electronic smart device(s) happens (such as 102 in FIGS. 1 and 203 in FIG. 2, FIG. 3, FIG. 4, FIG. 5), the device or content language will change based on cloud translation automatically. When devices match, then smart device(s)/internet of thing device(s)/internet of everything device(s) is ready to be used by consumer/traveler/end-user (such as 110 in FIGS. 1 and 219 in FIG. 2, FIG. 3, FIG. 4, FIG. 5). When consumer/traveler/end-user leaves the proximity area of the smart device(s)/internet of thing device(s)/internet of everything device(s), the smart devices or content may change back to default language and is available for next person (such as 120 in FIGS. 1 and 220 in FIG. 2, FIG. 3, FIG. 4, FIG. 5).

FIG. 6 illustrates an example of language changing on smart device(s)/internet of thing device(s)/internet of everything device(s) based on consumer/traveler/end-user personal smart mobile device or other personal electronic smart device(s) native language (locale). When communication connectivity between smart device(s)/internet of thing device(s)/internet of everything device(s) shown before translation 290 and consumer/traveler/end-user personal smart mobile device and/or other personal electronic smart device(s) 202 happens at 203, the smart device(s)/internet of thing device(s)/internet of everything device(s) changes language 295 to consumer/traveler/end-user native language and is ready to be used.

The above examples should not be construed as being limited but rather to convey the scope of the invention.

It is understood that that the above described arrangements are only illustrative of the application of the principles of the present invention. Numerous modification and alternative arrangements may be devised by those skilled in the art without departing from the spirit and scope of the present invention. Thus, while the present invention has been described above with particularity and detail in connection with what is presently deem to be the most practical and preferred embodiment(s) of the invention, it will be apparent to those of ordinary skill in the art that numerous modifications, including, but not limited to, variations in size, materials, shape, form, function, manner of operation, assembly, and use may be made without departing from the principles and concepts of the inventions.

It is understood that when an embodiment is referred hereinabove as being “placed on” another element, it can be directly on the other element or intervening elements may be present there between.

It is understood that when an embodiment is referred to hereinabove as a “personal electronic smart device” that it could be referencing a smart phone, smart tablet, smart watch, smart card, smart wearable, or any other personal smart devices as an example.

It is understood that when an embodiment is referred to hereinabove as a “traveler” or “consumer” or “end-user” that the reference is talking about the same person(s).

It is further understood that appropriate software and algorithms, housed or hosted on remote servers may be used for performing the various functions described here.

Spatially relative terms, such as “beneath,” “below,” “lower,” “above,” “upper,” “next to” and the like, are used herein for ease of description to describe one element or feature's relationship to another element(s) or feature(s) as illustrated in the figures. It is understood that the spatially relative terms are intended to encompass different orientations of the devices in use or operations in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

Example embodiments are described herein with references to cross section illustrations that are schematic illustrations of idealized embodiments. As such, variations from the shapes of the illustrations as a result, for example of manufacturing techniques and/or tolerances, are to be expected. Thus examples embodiments described herein should not be construed as limited to the particular shapes of regions as illustrated herein, but are to include deviations in shape or size that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes and/or sizes are not intended to illustrate the precise shape and/or size of a region and are not intended to limit the scope of the present claims.

It should be further understood that when an embodiment refers to communication between a personal smart device or personal mobile device (a personal electronic device), with a smart device/internet of thing device (s)/internet of everything device(s) (a smart device) it could also mean smart device with smart device communication or machine to machine communication or Internet of Thing (IoT) communication or Internet of Everything communication as an example.

In conclusion, herein is presented a system for automatically changing and/or configuring preferences/content for an internet of thing/smart device owned by someone else other than the traveler by referencing a consumer/end-user/travelers' personal electronic device(s) based on stored data mining elements. The disclosure is illustrated by examples throughout the written description and drawings. It should be understood that numerous variations are possible, while adhering to the inventive concept. Such variations are contemplated as being a part of the present disclosure.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A method for changing the language on smart device(s) or internet of thing device(s) or internet of everything device(s) (collectively hereinafter a “smart device”) based on the local native language of a consumer or traveler or end-user (hereinafter “user”) in accordance with the locale native language of the personal smart mobile device or other personal electronic smart device(s) (hereinafter collectively “personal electronic device”) or other smart device associated with said user, comprising
establishing communication between a personal electronic device, or smart device, of a user and a smart device or another smart device,
determining the user native language from the user's personal electronic device or from the smart device associated with said user; and
changing language or content language of the smart device to match the user's native language so that when the language of the smart device matches the user's native language based on the language of the user's personal electronic or smart device, then the smart device is ready to be used by the user.

2. The method according to claim 1, wherein changing the language or content language of the smart device to match the user's native language occurs automatically with no further action required by the user.

3. The method according to claim 1, wherein changing the language or content language of the smart device to match the user's native language occurs based on a pre-installed language.

4. The method according to claim 1, wherein changing the language or content language of the smart device to match the user's native language occurs by activation of a software application carried on said personal electronic device.

5. The method according to claim 1, wherein changing the language or content language of the smart device to match the user's native language occurs by activation of a software application carried on a cloud based server.

6. A system for changing the language on a smart device based on the local native language of a user in accordance with the locale native language on the personal electronic device or other smart device associated with said user, comprising
a personal electronic device or smart device under the control of a user, and a smart device not under the control of the user,
means for establishing communication between said personal electronic device or smart device of said user and said smart device not under the control of the user,
means for determining the user native language from the user's personal electronic or smart device; and
changing language or content language of the smart device to match the user's native language so that when the language of the smart device matches the user's native language based on the language of the user's personal electronic or smart device, then the smart device not under the control of the user is ready to be used by the user.

7. The system according to claim 6, further comprising software carried by said personal electronic device for changing the language or content language of the smart device to match the user's native language occurs automatically with no further action required by the user.

8. The system according to claim 6, further comprising a pre-installed language. wherein changing the language or content language of the smart device to match the user's native language occurs based on

9. The method according to claim 1, further comprising a software application carried on said personal electronic device for changing the language or content language of the smart device to match the user's native language.

10. The method according to claim 1, further comprising a software application carried on a cloud based server for changing the language or content language of the smart device to match the user's native language.
